(19) United States
(12) Patent Application Publication
(10) Pub. No.: US 2003/0228949 A1
(43) Pub. Date: Dec. 11, 2003

(54) Sintered sprocket and manufacturing method

(76) Inventors: Isamu Okabe, Osaka (JP); Kozo Ito, Hyogo (JP); Manabu Hashikura, Hyogo (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/424,307

(22) Filed: Apr. 28, 2003

(30) Foreign Application Priority Data
Jun. 3, 2002 (JP) 2002-161718

(51) Int. Cl. F16H 55/06; F16H 55/10

(52) U.S. Cl. 474/161; 74/462

(57) ABSTRACT

In a sintered sprocket at least the tooth surface layer contains carbon in the range from 0.6 to 1.2 mass % and nitrogen in the range from 0.05 to 0.5 mass %. The structure of the tooth surface layer comprises a tempered martensite structure and a residual austenitic structure, the residual austenitic structure being 10 to 50 volume % of the tooth surface layer. The density of the tooth surface layer is at least 7.4 g/cm³. Metallic elements contained in a base material comprise at least one metal selected from Ni, Cu and Mo in an amount in the range from 0.5 to 5 mass % the balance being Fe and inevitable impurities. The sintered sprocket exhibits high strength and wear resistance and can be manufactured at low cost.

### FIELD OF THE INVENTION

This invention relates to a sintered part, which is manufactured by molding metallic powders and sintering the molded metallic powders, and to a method of manufacturing the sintered part. It relates more specifically to a sintered sprocket having teeth for meshing with a chain used in a chain transmission mechanism in an internal combustion engine or the like.

### BACKGROUND OF THE INVENTION

Chains such as roller chains or the like have been used as transmission media in the timing mechanism of an automobile engine and in various other mechanisms. Sprockets composed of a sintered alloy have been used both as crankshaft (driving) sprockets and as camshaft (driven) sprockets.

These sprockets surface have been commonly subjected to hardening treatments such as quenching and tempering by high-frequency heating, or carburization quenching and tempering, to improve the strength and abrasive resistance of the tooth surfaces. (See Japanese Laid-open Patent Publication No. 2000-239710). Furthermore, in a sprocket which requires high abrasive resistance, and is used under severe conditions, a high-strength alloy steel (for example, chromium steel such as SCr 420 or the like, or chromium-molybdenum steel such SCM 420 or the like) has been used instead of a sintered alloy.

In recent years, silent chains have come into use as transmission media in place of roller chains in order to achieve greater quietness and compactness. However, a silent chain applies a greater pressure to the surfaces of the sprocket teeth. In the case of a high power engine or an engine operating under a high load, a conventional sintered alloy sprocket has insufficient strength and abrasive resistance.

In particular, in a direct injection type gasoline engine, in which fuel is injected directly into a cylinder of an engine, or in a diesel engine, carbon soot, which results from incomplete flame transmission or inadequate diffusion of fuel, accumulates as a residue in gaps between the timing chain and the sprockets. The accumulated carbon soot causes abrasion of the sprocket tooth surfaces. Therefore, the improvement of abrasive resistance in a sprocket is an important.

Furthermore, as a sprocket wears due to abrasion, powdered material from the sprocket enters the engine's lubricating oil. Then, since the powder acts as an abrasive material, wear occurs not only in the sprockets and chain, but also in engine accessories such as a chain tensioner lever, a chain guide, and the like, which are included as parts of the engine timing transmission. As wear of the sprocket proceeds, jumping of the chain on the teeth of the sprocket can occur due to meshing irregularities, and in the worst case, breakage of a tooth of the sprocket can lead to engine failure or to serious damage to the engine.

On the other hand, in the case where an alloy steel such as chromium steel or chromium-molybdenum steel or the like is used as the sprocket material, the material cost is high compared to the cost of sintered alloy steel. Therefore, in view of the trend in recent years toward cost reduction in engines, there has been an urgent need to solve the objectives of low cost, high strength and high abrasion resistance, which have heretofore involved a trade-off.

Accordingly, the objects of the invention are to solve the problems of conventional sprockets as described above, and to provide a sintered sprocket, which is low in cost and has high strength and superior wear resistance.

### SUMMARY OF THE INVENTION

To address the above-mentioned objects, at least a tooth surface layer of the sprocket in accordance with the invention contains, by mass %, carbon: 0.6 to 1.2% and nitrogen: 0.05 to 0.5%.

When the carbon content is less than 0.6 mass %, only a small increase in hardness of the base steel is realized, and when the carbon content exceeds 1.2 mass %, cementite, a hard carbide having the formula Fe₃C, is precipitated. The cementite causes quenching cracking during heat treatment, and the cementite runs out of the base steel, causing abrasive wear. Accordingly the range of 0.6-1.2% is preferable.

On the other hand, when the nitrogen is present in an amount less than 0.05 mass %, only a small improvement in hardness of the base steel is realized, and the resistance to softening in tempering is small. When the nitrogen content exceeds 0.5 mass %, brittle iron nitride is readily generated, and drops out of the base steel of the sprocket in use, causing abrasive wear. Accordingly the range of 0.05-0.5% is preferred.

The sintered sprocket preferably also comprises a tempered martensite structure and a residual austenitic structure, the residual austenitic structure constituting from 10-50 volume % of the tooth surface layer. If the residual austenitic structure is less than 10 volume %, any improvement in abrasion resistance is small, and when residual austenitic structure exceeds 50 mass %, the hardness of the sprocket is decreased, and its abrasion resistance is reduced.

In the sintered sprocket the density of the tooth surface layer is also preferably at least 7.4 g/cm³. When the density of the tooth surface layer is less than 7.4 g/cm³, the possibility of generating wear due to pitting on the surface layer of the sprocket, as a result of contact surface pressure applied by the chain, is increased

From 0.5 to 5 mass % of the content of the base material of the sprocket preferably comprises at least one metal selected from the group consisting of Ni, Cu and Mo while the balance consists of Fe and impurities, which are inevitable. Nickel improves the strength and toughness of the base steel in the sintered sprocket. Copper produces a liquid phase in sintering of the sprocket and promotes the diffusion of alloying elements, thereby improving the strength of the base steel. Molybdenum improves hardness, strength and resistance to softening, by tempering of the base steel. Suppression of abrasive wear on the sprocket tooth surfaces can be obtained by the action of at least one of the elements Ni, Cu and Mo. However, when the total amount of these elements is less than 0.5 mass %, the effects of the elements are not sufficient, and if they exceed 5 mass %, their effects become saturated, the compressibility of the raw material powder in press molding decreases, and an undesirable increase in density occurs.

In the process of manufacturing the sintered sprocket, the sprocket is subjected to a carburization-nitriding quenching step followed by a tempering step. In the carburization-nitriding quenching step the tooth surface layer of the sprocket is carburized and nitrogenized while being heated at a temperature in the range from 800 EC to 950 EC. In the subsequent tempering step, the quenched sprocket is tempered at a temperature of 140 EC to 220 EC. When the carburizing and nitriding temperature is less than 800 EC, diffusion of carbon and nitrogen is insufficient and any increase in hardness is small. If the temperature exceeds 950 EC, carbon and nitrogen are diffused not only into the surface layer but also into the interior of the sprocket, thereby decreasing its shock resistance. When the tempering temperature is less than 140 EC, the shock resistance of the sprocket is not sufficient, and when the tempering temperature exceeds 220 EC, the hardness of the sprocket and its wear resistance are both decreased.

The carburization-nitriding quenching step is preferably carried out in the same furnace subsequent to a carburization step in which only carburization is performed. In the carburization step, the carbon content of the atmosphere in the furnace is set to 1.0 to 1.5 mass %, and in the carburization-nitriding quenching step, in which nitriding is performed at the same time, the carbon content of the atmosphere in the furnace is set to 0.6 to 1.2 mass %. These steps may be performed continuously in the same furnace.

When the carbon content in the carburization step is less than 1.0 mass %, the diffusion of carbon becomes insufficient and hardening depth cannot be ensured. When the carbon content in the carburization step exceeds 1.5 mass %, the diffusion of carbon to the interior of the sprocket becomes excessive, thereby decreasing the shock resistance of the sprocket. Furthermore, when the carbon content in the carburization and nitriding step is less than 0.6 mass %, the amount of carbon in a tooth surface layer is insufficient and the hardness of the sprocket cannot be ensured, and when the carbon content exceeds 1.2 mass %, undesirable precipitation of hard cementite occurs at an original powder boundary, or a grain boundary, due to excessive diffusion of carbon.

As described above, the reason why it is desirable that the carburization step and carburization and nitriding step be differentiated from each other by different carbon content ranges, is that, when nitriding is simultaneously performed in an atmosphere having a high carbon content, excessively residual austenite is produced, which reduces the hardness of the sprocket. Furthermore, by continuously performing the carburization step and the carburization and nitriding step in the same furnace the manufacturing installation can be simplified so that the manufacturing cost can be reduced. The nitriding in the carburization and nitriding step can be usually performed by adding NH₃ gas into the atmospheric gas in the furnace.

In addition to the carburization-nitriding quenching step and the tempering step, a graining step may also be carried out. In the graining step, the tooth surface layer is closely grained by sizing or rolling so that the density of the tooth surface layer is at least 7.4 g/cm³. Sizing or rolling easily allows the close-graining of only the tooth surface layer, and it is possible to obtain a density of the tooth surface layer of 7.6 g/cm³or more. The surface graining step, the carburization and nitriding step, and the tempering step allow effective manufacture of a sintered sprocket having an excellent wear resistance.

According to the invention, the strength and wear resistance of the sprocket are enhanced, and even in a case where the sintered sprocket is used in adverse environments in a diesel engine, a direct injection gasoline engine or the like, little or no abrasive wear is generated, and smooth rotation of the sprocket can take place over a long period of time.

Furthermore, using the manufacturing method of the invention, a sintered sprocket having enhanced strength and excellent wear resistance can be reproducibly manufactured at low cost.

### BRIEF DESCRIPTION OF THE DRAWING

FIG. 1 is a graph showing the results of wear tests on sintered sprockets in accordance with the invention.

### DETAILED DESCRIPTION OF THE PREFERRED EMBODIMENTS

Preferred embodiments of a sintered sprocket in accordance with the invention, and its manufacturing method, will be described with reference to the following examples.

Sintered sprockets in accordance with the invention were manufactured as follows. Four kinds of iron based powder A, B, C and D, were used.

A: Ni: 2 mass %, Mo: 1.5 mass %, and the balance Fe and inevitable impurities;

B: Ni: 0.5 mass %, Mo: 1.0 mass %, and the balance Fe and inevitable impurities;

C: Mo: 0.8 mass %, and the balance Fe and inevitable impurities; and

D: Ni: 1.8 mass %, Cu: 1.5 mass %, Mo: 0.5 mass %, and the balance Fe and inevitable impurities.

To each of the these iron-based powders, lubricant and graphite powder in the amounts shown in Table 1 were mixed, and the respective mixed powders were molded into sprocket shapes by compression molding as shown in Table 1. In this case, any compressing molding steps were performed at a pressure of 686 MPa.

TABLE 1

| | | AMOUNT OF | | | | |
|---|---|---|---|---|---|---|
| | IRON | GRAPHITE | | CLOSELY | HEAT | |
| SAMPLE | BASE | FORMULATION | MOLDING | GRAINING | TREATMENT | |
| NO. | POWDER | (MASS %) | PROCESS | PROCESS | PROCESS | REMARKS |
| 1 | A | 0.2 | Hot | Strongly | Carburization | Example of |
| | | | | sizing | and | the invention |
| | | | | | nitriding | |
| 2 | ↑ | ↑ | Cold | ↑ | ↑ | Example of |
| | | | | | | the invention |
| 3 | ↑ | ↑ | Mold | ↑ | ↑ | Example of |
| | | | lubrication | | | the invention |
| 4 | ↑ | ↑ | Cold | Rolling | ↑ | Example of |
| | | | | | | the invention |
| 5 | ↑ | ↑ | Hot + Mold | Non | ↑ | Example of |
| | | | lubrication | | | the invention |
| 6 | B | ↑ | Hot | Strongly | ↑ | Example of |
| | | | | sizing | | the invention |
| 7 | C | ↑ | ↑ | ↑ | ↑ | Example of |
| | | | | | | the invention |
| 8 | D | ↑ | ↑ | ↑ | ↑ | Example of |
| | | | | | | the invention |
| 9 | A | ↑ | ↑ | ↑ | Carburization 1 | Comparative |
| | | | | | | example |
| 10 | ↑ | ↑ | ↑ | ↑ | Carburization 2 | Comparative |
| | | | | | | example |
| 11 | ↑ | 0.7 | ↑ | ↑ | High frequency | Comparative |
| | | | | | | example |
| 12 | ↑ | ↑ | ↑ | ↑ | Gas soft nitriding | Comparative |
| | | | | | | example |

In the molding process shown in Table 1, the term “hot” or “cold” refer respectively to a method of heating a mold and mixed powder at 130 EC and to a method of compression-molding the mixed powder at room temperature. Further, the term “mold lubricating” refers to a method of applying a lubricant to a mold without adding the lubricant to the mixed powder, and compression-molding the mixed powder at room temperature. The term “hot+mold lubrication” refers to a method of heating the mold and the mixed powder at 130 EC in the mold, applying lubricant to the mold rather than to the mixed powder, and performing compression-molding.

After the molded-form, compression-molded by the above-described method, has been sintered at 1150 EC in a nitrogen atmosphere, close-graining was performed by the processes indicated in Table 1 to increase the density of the tooth surface layer of the sprocket. The term “strongly sizing” refers to a method of increasing the squeezing margin to 0.1 mm or more to close voids on the tooth surface layer. The term “rolling” refers to a method of relatively rolling a sintered body while it is disposed between close graining dies, thereby to closely-grain the tooth surface layer of the sprocket. The depths of the closely-grained layers having a density of 7.4 g/cm³ or more produced by strongly sizing or rolling were in the range of 0.2 to 0.8 mm in any case.

Then, after the above-mentioned closely grained sintered products were finished by machining to the desired shapes and dimensional accuracy, heat treatment was performed by “carburization and nitriding” process indicated in Table 1. In this case, carburization was performed by heating the sintered product in an atmosphere having a carbon content of 1.2 mass % at a temperature of 900 EC. Then, while further carburizing the product in the same furnace in an atmosphere having a carbon content of 0.8 mass % at a lowered temperature of 850 EC, NH₃ gas was introduced into the furnace to perform nitriding. After carburization, and carburization-nitriding, the sprocket product was immersed in oil to quench it, and was tempered at a temperature of 180 EC in air.

The heat treatment process designated “carburization 1” in Table 1, was performed by heating the sintered product in an atmosphere having a carbon content of 1.2 mass % at a temperature of 900 EC to carburize it, and then further carburizing the product in the same furnace in an atmosphere having a carbon content of 0.8 mass % at a lowered temperature of 850 EC. After that the sprocket was immersed in oil to quench it, and was tempered at a temperature of 180 EC in the air.

The heat treatment process designated “carburization 2” in Table 1, was performed by heating the sintered product in an atmosphere having a carbon content of 1.2 mass % at a temperature of 900 EC to carburize it immersing the sintered product in oil to quench it. Then the product was tempered at a temperature of 180 EC in the air.

The heat treatment process designated “high-frequency” in Table 1, was performed by heating the tooth portion of the sprocket at a temperature of 900 EC by high frequency inductive heating at a frequency of 120 kHz, and injecting oil to the tooth portion to quench it. After that, the tooth portion was tempered at a temperature of 180 EC in air.

The heat treatment process designated “gas soft nitriding” in Table 1, was performed by heating the sintered sprocket at a temperature of 570 EC in a mixture of nitrogen, ammonia, and propane gases, and cooling the product in air. As a result, an iron nitride layer having a thickness of 10:m was produced on the tooth surface layer of the sprocket.

With the samples No. 1 to 12 manufactured by the above-described processes, the density, carbon content (mass %), nitrogen content (mass %), ratio (volume %) of residual austenitic structure and structure of the tooth surface layer were measured. The results are shown in Table 2. The marks “residual (”, “M” and “B” represent “residual austenitic structure”, “martensite structure” and “bainitic structure” respectively.

TABLE 2

| | | | CARBON | NITROGEN | | |
|---|---|---|---|---|---|---|
| | | | CONTENT | CONTENT | | |
| | DENSITY (G/CM³) | | (MASS %) | (MASS %) | | STRUCTURE |
| | TOOTH | | TOOTH | TOOTH | AMOUNT OF | OF |
| SAMPLE | SURFACE | CENTER | SURFACE | SURFACE | RESIDUAL γ | TOOTH |
| NO. | LAYER | PORTION | LAYER | LAYER | (VOLUME %) | SURFACE |
| 1 | 7.6 | 7.2 | 0.8 | 0.1 | 32 | M + residual |
| | | | | | | γ |
| 2 | 7.5 | 7.0 | 0.8 | 0.1 | 41 | ↑ |
| 3 | 7.6 | 7.3 | 0.8 | 0.1 | 28 | ↑ |
| 4 | 7.7 | 7.0 | 0.8 | 0.1 | 35 | ↑ |
| 5 | 7.4 | 7.4 | 0.8 | 0.1 | 25 | ↑ |
| 6 | 7.6 | 7.2 | 0.8 | 0.1 | 44 | ↑ |
| 7 | 7.6 | 7.2 | 0.8 | 0.1 | 15 | ↑ |
| 8 | 7.6 | 7.2 | 0.8 | 0.1 | 33 | ↑ |
| 9 | 7.6 | 7.2 | 0.8 | 0.03 | 4 | ↑ |
| 10 | 7.6 | 7.2 | 1.2 | 0.03 | 8 | ↑ |
| 11 | 7.6 | 7.2 | 0.7 | 0.03 | 4 | ↑ |
| 12 | 7.6 | 7.2 | 0.7 | 1.1 | 7 | Nitride |
| | | | | | | layer + B + |
| | | | | | | residual γ |

To check the effects of the sintered sprockets of invention, wear tests of the respective sprockets were conducted by a motoring testing machine under the following conditions:

Chain: Silent chain having a pitch of 6.35 mm;

Number of teeth of the sprockets: 23 and 46;

Chain load: 1.5 kN;

Rotating speed: 6500 r.p.m (23 tooth driving sprocket);

Testing time: 200 hours.

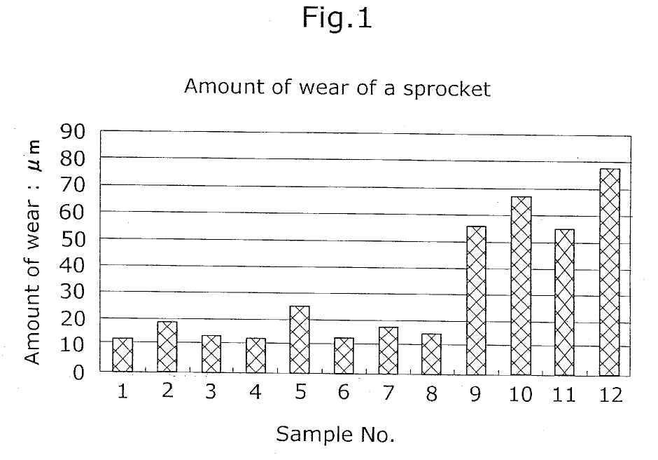

The amount of wear in a tooth surface was measured. The test results are shown in FIG. 1.

As can be seen from values shown in FIG. 1 and Table 2, in the samples 1 to 8 (which correspond to the invention, and which have carbon contents of 0.6-1.2 mass % and nitrogen contents of 0.05-0.5 mass %, any amounts of wear are approximately 20 :m or less. On the other hand, in samples 9 to 12 (the comparative examples), which deviate from the aforementioned ranges of carbon and nitrogen contents, the amounts of wear exceed 55:m. Samples 1 to 8 exhibited significantly greater wear resistance compared to the samples 9 to 12, the wear of the comparative examples being approximately three times the wear of the samples in accordance with the invention.

Further, as can be seen from Table 2, each of the samples Nos. 1 to 8 (in accordance with the invention) consists of a martensite structure and a residual austenitic structure, and the content ratio of the residual austenitic structure was 10 to 50 volume %. On the other hand, samples 9 to 12 (the comparative examples) deviated from this condition.

The densities of the tooth surface layers in the sintered sprockets according to the invention were 7.4 g/cm³ or more. Furthermore, the metallic elements contained in the base material were at least one of elements in the group consisting of Ni, Cu and Mo constituting about 0.5-5 mass % of the base material, the balance being Fe and inevitable impurities.

Chains used together with the sintered sprocket of the invention can be of various types, including both roller chains and silent chains. In the case in which the sintered sprocket is used with a silent chain, the superiority of the invention becomes more significant than in the case of a roller chain, because the silent chain applies high pressure to sprocket tooth surfaces and requires high wear resistance in the sprocket. The sintered sprockets of the invention may be applied to various applications such as a transmission mechanism, a conveyer, an elevator and the like. However, they are especially advantageous in the case of a direct injection gasoline engine and a diesel engine, both of which require special measures against abrasive wear.

As described above in detail, according to the invention, the strength and wear resistance of the sprocket are enhanced, and even in a case where the sintered sprocket is used in adverse environments such as in a diesel engine or direct injection engine or the like, little or no abrasive wear is generated, and smooth rotation of the sprocket is achieved over a long period of time. Further, since wear of sprocket and chain tooth surfaces is reduced, the optimum meshing shape of the chain and sprocket teeth can be maintained for a long period of time, and the occurrence of meshing collision noise can be suppressed over a long period of time. Thus, using the sintered sprocket of the invention, a chain transmission mechanism having excellent quietness can be realized, and at the same time the wear of other engine parts due to the entry of powder from the sprocket into the lubricating oil can be suppressed. Furthermore, the occurrence of tooth jumping due to wear of a sprocket, and engine failure and damage due to the breakage of a tooth and the like avoided. Durability and reliability of the engine are significantly improved.

By using the manufacturing method of the of the invention, a sintered sprocket having enhanced strength and excellent wear resistance can be reproducibly manufactured. Furthermore, since a strongly sizing step or a carburization and nitriding step used in the manufacturing method of the invention can be carried out using conventional equipment, no special capital investment is needed. The manufacture of a sintered sprocket in accordance with the invention is very advantageous, especially because its manufacturing cost is significantly lower than that of sprockets produced by processes such as forging or machining alloyed steel.

What is claimed is:

1. A sintered sprocket in which at least a tooth surface layer of the sprocket contains, by mass %, carbon: 0.6 to 1.2% and nitrogen: 0.05 to 0.5%.

2. A sintered sprocket according to claim 1, in which the structure of said tooth surface layer comprises a tempered martensite structure and a residual austenitic structure, and said residual austenitic structure constitutes from 10 to 50 volume % of said tooth surface layer.

3. A sintered sprocket according to claim 1, in which the density of said tooth surface layer is at least 7.4 g/cm³.

4. A sintered sprocket according to claim 2, in which the density of said tooth surface layer is at least 7.4 g/cm³.

5. A sintered sprocket according claim 1, in which said sprocket comprises a base material, and in which from 0.5 to 5 mass % of the content of said base material comprises at least one metal selected from the group consisting of Ni, Cu and Mo and the balance consists of Fe and impurities.

6. A sintered sprocket according claim 2, in which said sprocket comprises a base material, and in which from 0.5 to 5 mass % of the content of said base material comprises at least one metal selected from the group consisting of Ni, Cu and Mo and the balance consists of Fe and impurities.

7. A sintered sprocket according claim 3, in which said sprocket comprises a base material, and in which from 0.5 to 5 mass % of the content of said base material comprises at least one metal selected from the group consisting of Ni, Cu and Mo and the balance consists of Fe and impurities.

8. A sintered sprocket according claim 4, in which said sprocket comprises a base material, and in which from 0.5 to 5 mass % of the content of said base material comprises at least one metal selected from the group consisting of Ni, Cu and Mo and the balance consists of Fe and impurities.

9. A method of manufacturing a sintered sprocket comprising a carburization-nitriding quenching step in which a tooth surface layer of a sprocket is carburized and nitrogenized while being heated at a temperature in the range from 800° C. to 950° C., and a tempering step in which the quenched sprocket is subsequently tempered at a temperature of 140° C. to 220° C.

10. A method of manufacturing a sintered sprocket according to claim 9, in which said carburization-nitriding quenching step is carried out in the same furnace subsequent to a carburization step in which only carburization is performed, and in which, in said carburization step, the carbon content of the atmosphere in said furnace is set to 1.0 to 1.5 mass %, and in said carburization-nitriding quenching step, in which nitriding is performed at the same time, the carbon content of the atmosphere in said furnace is set to 0.6 to 1.2 mass %.

11. A manufacturing method of a sintered sprocket according to claim 9 comprising, in addition to said carburization-nitriding quenching step and said tempering step, a step in which a tooth surface layer is closely grained by sizing or rolling so that the density of the tooth surface layer is at least 7.4 g/cm³.

12. A manufacturing method of a sintered sprocket according to claim 10 comprising, in addition to said carburization-nitriding quenching step and said tempering step, a step in which a tooth surface layer is closely grained by sizing or rolling so that the density of the tooth surface layer is at least 7.4 g/cm³.
